(19) United States
(12) Patent Application Publication
(10) Pub. No.: US 2018/0337932 A1
(43) Pub. Date: Nov. 22, 2018

(54) CYBER-PHYSICAL SECURITY

(71) Applicant: SECUREPUSH LTD., Migdal Tefen (IL)

(72) Inventors: Bernard JUSTER, Netanya (IL); Guy GAFNI, Moshav Ben-Ami (IL); David ZEHAVI, Neveh Ziv (IL); Simon STOLERO, Nahariya (IL)

(21) Appl. No.: 15/596,072

(22) Filed: May 16, 2017

(51) Int. Cl. H04L 29/06; H04L 9/32; G06F 21/85; G06F 21/35

(52) U.S. Cl. CPC H04L 63/145; H04L 63/1416; G06F 21/35; G06F 21/85; H04L 9/3234

(57) ABSTRACT

A cyber-physical security module includes an input interface configured to connect to a signal source to intercept a physical signal that is transmitted from the signal source to a signal destination. An output interface is configured to connect to the signal destination. A programmable processor is configured to receive input from an administrator device to define or modify one or a plurality of security rules. Upon interception of the physical signal via the input interface, the processor is configured to apply the security rules to authenticate the intercepted physical signal. If the intercepted physical signal is authenticated, the processor is configured to transmit the intercepted physical signal to the signal destination via the output interface.

### FIELD OF THE INVENTION

The present invention relates to security. More particularly, the present invention relates to a system and method for cyber-physical security.

### BACKGROUND OF THE INVENTION

A typical cybersecurity solution operates in the digital cyberspace that includes computers, enterprise servers, cloud-based data centers, network equipment, and similar systems. The threats to software, hardware devices, or embedded software (e.g., firmware, such as that found in microcontrollers) typically originate from the cyber world, e.g., via a local area network (LAN), wide area network (WAN), Wi-Fi, or other types of networks.

In particular, such cybersecurity systems process strings or packets of digital information. For example, such a cybersecurity system may compare a port number in a Transmission Control Protocol (TCP) packet against a blacklist or whitelist (e.g., in a simple firewall), examine contents of a file against known viruses, or otherwise examine the encoded data content in a transmitted signal.

Awareness of threats to hardware devices, such as to motors, actuators, valves, sensors, on/off switches, lights, and other devices became widespread in 2010 with reporting of attacks by the Stuxnet worm. According to security experts, the attack by the Stuxnet worm on Iranian centrifuges was the first attack that enabled hackers to manipulate equipment. The Stuxnet malware could attack large scale industrial facilities such as power plants, dams, waste processing systems, and similar operations.

Threats to physical devices may be also in the consumer mass market and the enterprise environment. For example, hackers have been known to have developed devices that can enable access to automobiles or to open garage doors. A system has been demonstrated that extracts confidential information from a highly secure server equipped with data leak protection (DLP) measures by using a smart light controller of an office.

Although a cyber-physical attack may original in cyberspace (e.g., via the cloud, Internet. WAN, LAN, servers, or otherwise), the cyberspace channel (and their typically heavy cybersecurity mechanisms) could be bypassed altogether. For example, although the Stuxnet worm originated in cyberspace, in order to reach the centrifuges whose controller was physically disconnected from the Internet, it infected a Universal Serial Bus (USB) memory stick that was plugged into the programmable logic controller (PLC) of the centrifuges.

Side channel attacks may also bypass cyberspace. Examples of side channel attacks include a power-monitoring attack that measures variations in power consumption by the hardware during operation, an electromagnetic attack based on leaked electromagnetic radiation, and acoustic cryptanalysis that utilizes sound that is produced during a computation. Such measurements could be used to infer cryptographic keys or can be used in non-cryptographic attacks (e.g., TEMPEST attacks).

Such threats and attacks on physical systems may be expected to become more frequent due to various factors and trends. Physical devices that can be accessed via the Internet, generally known as the Internet of Things, (IoT), are becoming more common in such contexts as home automation (e.g., connected or “smart” lights, smart switches, smart locks, smart/connected home appliances), the automotive field (e.g., connected Electronic Control Units (ECU), fleet management systems, autonomous driving, remote maintenance), smart grids, healthcare (e.g., connected medical devices, connected medical sensors), industry, and other areas.

### SUMMARY OF THE INVENTION

There is thus presented, in accordance with an embodiment of the present invention, a cyber-physical security module including: an input interface configured to connect to a signal source to intercept a physical signal that is transmitted from the signal source to a signal destination; an output interface configured to connect to the signal destination; and a programmable processor that is configured to: receive input from an administrator device to define or modify one or a plurality of security rules; upon interception of the physical signal via the input interface, apply the one or a plurality of security rules to authenticate the intercepted physical signal; and if the intercepted physical signal is authenticated, transmit the intercepted physical signal to the signal destination via the output interface.

Furthermore, in accordance with an embodiment of the present invention, the signal source includes a controller and the signal destination includes a controlled device.

Furthermore, in accordance with an embodiment of the present invention, the signal source includes a controlled device and the signal destination includes a controller.

Furthermore, in accordance with an embodiment of the present invention, the physical signal includes a sensor signal.

Furthermore, in accordance with an embodiment of the present invention, the cyber-physical security module includes an interface to a beacon.

Furthermore, in accordance with an embodiment of the present invention, the security rule includes proximity of a security entity as detected by operation of the beacon.

Furthermore, in accordance with an embodiment of the present invention, the security entity includes a user device or a token.

Furthermore, in accordance with an embodiment of the present invention, the security rule includes communicating with a user device via the beacon.

Furthermore, in accordance with an embodiment of the present invention, the security rule includes receipt of an authentication verification message from a user device or from a server.

Furthermore, in accordance with an embodiment of the present invention, the security rule includes proximity of a beacon.

Furthermore, in accordance with an embodiment of the present invention, the cyber-physical security module includes a data storage, the processor being further configured to store the intercepted physical signal in the data storage.

There is further provided, in accordance with an embodiment of the present invention, a cyber-physical security method, the method including: intercepting a physical signal by a cyber-physical security module from a signal source that is connected to an input interface of the cyber-physical security module; storing the intercepted physical signal on a data storage; applying one or a plurality of security rules to authenticate the intercepted physical signal; and, if the intercepted physical signal is authenticated, transmitting the stored physical signal to a signal destination that is connected to an output interface of the cyber-physical security module.

Furthermore, in accordance with an embodiment of the present invention, the signal source includes a controller, and the signal destination includes a controlled device.

Furthermore, in accordance with an embodiment of the present invention, the signal source includes a controlled device, and the signal destination includes a controller.

Furthermore, in accordance with an embodiment of the present invention, the physical signal includes a sensor signal.

Furthermore, in accordance with an embodiment of the present invention, applying the security rule includes transmitting an authentication request message to a user device or to a server.

Furthermore, in accordance with an embodiment of the present invention, applying the one or a plurality of security rules includes detecting the proximity of a token.

Furthermore, in accordance with an embodiment of the present invention, applying the one or a plurality of security rules includes detecting the proximity of a user device.

Furthermore, in accordance with an embodiment of the present invention, applying the one or a plurality of security rules includes detecting the proximity of a beacon.

Furthermore, in accordance with an embodiment of the present invention, the method includes receiving input from an administrator device to define or modify said one or a plurality of security rules.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a system incorporating a cyber-physical security module, in accordance with an embodiment of the present invention.

FIG. 2 is a schematic block diagram of an example of the cyber-physical security module of the system shown in FIG. 1.

FIG. 3 is a schematic block diagram of elements of an example of the system shown in FIG. 1.

FIG. 4 is a flowchart depicting a method for cyber-physical security, in accordance with an embodiment of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

In accordance with an embodiment of the present invention, a system with an electrically or electronically controlled device includes a cyber-physical security module. The cyber-physical security module is configured to limit transmission of physical signals between a device controller and a controlled device in accordance with a programmed condition. As used herein, a physical signal refers an electrical signal (e.g., which may include an electromagnetic, photonic, or other signal that is converted to an electrical signal) that is measurable as a change in voltage or current, without regard to encoded content of the signal, if any. For example, a physical signal may include and continuous or pulsed analog or digital signal that is sent by a controller to an actuator to cause movement of the actuator. As another example, a physical signal may include a signal that is generated by a sensor in response to a sensed characteristic (e.g., a voltage that increases proportionally to a sensed quantity).

For example, the cyber-physical security module may include a controller connector that is configured to connect to a device controller. The controller connector may include a general purpose, adaptable or configurable connector that may be adapted to a wide variety of device controllers (e.g., varying in terms of shape or type of connector, range of voltage, current, power, impedance, or otherwise). Alternatively or in addition, the controller connector may be designed or configured for connection to a particular device controller, or to a family of similar device controllers.

The cyber-physical security module may include a device connector that is configured to connect to a controlled device. Again, the device connector may include a general purpose, adaptable or configurable connector that may be adapted to a wide variety of controlled devices (e.g., varying in terms of shape or type of connector, range of voltage, current, power, impedance, or otherwise). The device connector may be designed or configured for connection to a particular controlled device, or to a family of similar controlled devices. For example, a controlled device may include a motor, actuator, valve, sensor, switch, light, or other controllable device.

When the cyber-physical security module is connected to the device controller and the controlled device, all signals that are transmitted from the device controller to the controlled device, and vice versa, are channeled through the cyber-physical security module.

The cyber-physical security module may be configured to identify a triggering signal that is received from the device controller or from the controlled device, apply an authentication procedure, and, if authentication is successful, transmit the triggering signal to its destination (the controlled device or the device controller, respectively).

The cyber-physical security module includes a processor that is configured to operate in accordance with programmed instructions that are stored on a data storage device of the cyber-physical security module. The programmed instructions may define a triggering input signal, define an authentication procedure, define an output signal, or other procedures. A suitable programming language may be provided to facilitate programming by an operator or installer of the cyber-physical security module. For example, the programming language may include primitive functions that are similar to a standard written language and that may be sequenced to provide programmed instructions of operation of the cyber-physical security module.

An authentication procedure may include, in some cases, verifying that the input signal corresponds to one or more criteria. For example, a criterion may include limit on the strength of the signal (e.g., a voltage or power that corresponds to a limit of operation of the controlled device, such as a maximum speed or applied three). A criterion may include a signal transition from a low value to a high value (leading edge), or from a high value to a low value (falling edge). A criterion may include a time limit. The time limit may be independent of signal strength, or may depend on the signal strength (e.g., a time limit for a signal whose strength is within a predetermined voltage or power range).

The authentication procedure may include detection of, communication with, or otherwise interacting with, one or more authentication entities. For example, an authentication entity may include one or more persons, devices, beacons, or other entities that may be utilized in authenticating an input signal.

In some cases, the authentication procedure may include a geographical limit a on a location of an authentication entity in the form of a user device. For example, the cyber-physical security module may be configured to detect the proximity of a user device that is expected to be carried on or near a user that operates the device controller. Such user devices may include a mobile communications device (e.g., a smartphone or other mobile telephone, a portable computer, a vehicle-mounted computer, or other mobile communications device), a token (e.g., an IEEE 802.15.4 token), a beacon (e.g., an IEEE 802.15.4 beacon), or other user device that is expected to be found on the person of a user, or near the user.

For example, the cyber-physical security module may verify that an authentication entity in the form of a mobile communications device is within range of, or within a predetermined distance of, a Bluetooth low energy (BLE) beacon of the cyber-physical security module. Alternatively or in addition, the cyber-physical security module may verify that an IEEE 802.15.4 token of an IEEE 802.15.4 beacon of the cyber-physical security module. Alternatively or in addition, the cyber-physical security module may verify that a beacon an IEEE 802.15.4 beacon) that is associated with the user, e.g., installed in a vehicle that is associated with the user, is within range of, or within a predetermined distance of, the cyber-physical security module.

In some cases, the authentication procedure may include requiring a user to perform an action. For example, the cyber-physical security module may send an authentication request to a mobile communications device that is associated with the user. For example, the authentication request may include displaying an authentication request message on the mobile communications device. The message may indicate the type of signal that was received from the device controller, e.g., as an indication of an expected result of transmitting the message to the controlled device. The user may operate the mobile communications device (e.g., tap on a screen button that is displayed by the mobile communications in association with the displayed authentication request message, or otherwise operate the mobile communications device) to indicate approval or authentication of the received signal.

For example, an authentication request message may be transmitted to the mobile communications device via a Bluetooth channel. Alternatively or in addition, the authentication request message may be transmitted to the mobile communications device via a messaging or notification service that is associated with the mobile communications device operates Google Cloud Messaging service for Android, Apple notification service for iPhone/IOS, or another service). An authorization response by the user may be transmitted from the mobile communications device to the cyber-physical security module by a similar channel.

If the authentication procedure is successful, the received signal (e.g., a signal that is identical to the received signal) may be transmitted to the destination. For example, if the signal was received from the device controller (e.g., representing a command to the controlled device), the signal may be transmitted from the cyber-physical security module to the controlled device. If the signal was received from the controlled device (e.g., representing a sensor reading), the signal may be transmitted from the cyber-physical security module to the device controller.

A cyber-physical security module in accordance with an embodiment of the present invention may be advantageous over other types of the security systems for protecting devices, e.g., as part of Internet of Things (IoT) technology. For example, end-point security as described herein may enable protection of endpoints (e.g., a controller or controlled device) in cases in which traditional authentication and cryptography cannot be implemented due to resource constraints and long device life cycles outliving encryption effectiveness. Since the cyber-physical security module connects to the device and controller, the cyber-physical security module may enable anti-tampering function for devices used in high-risk environments, without sacrificing personal data privacy expectations. The cyber-physical security module protects the “last inch” before the protected device, as opposed to many cybersecurity measures that provide protection at earlier stages (e.g., for communication over a network). As opposed to existing cybersecurity mechanisms (e.g., firewall, antivirus, user authentication, encryption, and other cybersecurity mechanisms) that provide security by processing data that has already been digitized and are pure software solutions, the cyber-physical security module processes data (analog or digital) directly at the hardware level.

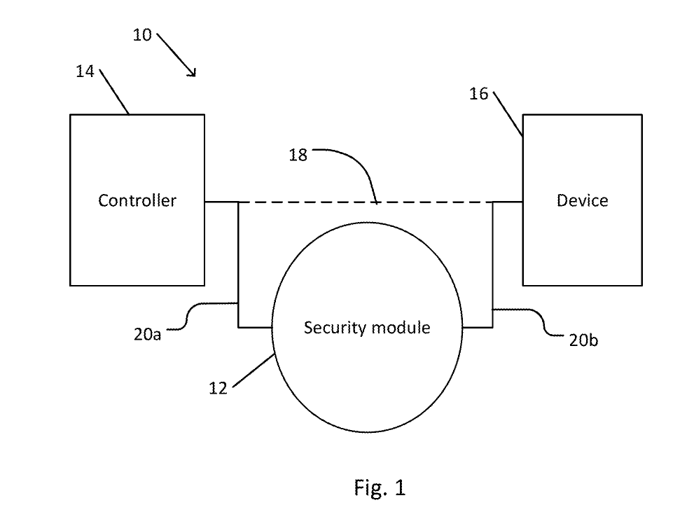

FIG. 1 schematically illustrates a system incorporating a cyber-physical security module, in accordance with an embodiment of the present invention.

Cyber-physical security system 10 includes device controller 14, controlled device 16, and cyber-physical security module 12. Cyber-physical security system 10 may include a plurality of device controllers 14, controlled devices 16, or both.

For example, controlled device 16 may include an actuator, motor, switch, light, valve, lock, or other device that may be activated by a signal that is generated by device controller 14. In some cases, a controlled device 16 may include a sensor, timer, or other output producing device. Device controller 14, controlled device 16, or both, may include two or more devices that operate in coordination with one another. For example, a device controller 14 may be configured to operate an actuator of controlled device 16 in accordance with a condition that is sensed by a sensor of (the same or a different) controlled device 16.

An example of such a device may be a garage door opener. In this case, controlled device 16 corresponds to a motor assembly that operates to open (e.g., lift) or close (e.g., lower) a garage door. Device controller 14, then, may correspond to a control unit that is configured to receive a signal from a manually operated switch, or from a remote control unit, and to send a command signal to device controller 14 to open or close the garage door. Other examples of controlled devices 16 may include a smart lighting system (e.g., where device controller 14 corresponds to a controller that is configured to receive a signal from a light sensor or from a remote control unit and to turn on the light when indicated), a temperature controlled air-conditioning system (e.g., where device controller 14 corresponds to a controller that that is configured to receive a signal from a temperature, humidity, or other sensor, or from a remote control unit, and to operate the air conditioner accordingly), a remotely controlled vehicle ignition system, an elevator, or other controlled device.

Typically, device controller 14 and controlled device 16 are located in close proximity to one another, e.g., in a single housing or in separate housings that are connected by a cable connection. In a typical system where, cyber-physical security module 12 is not installed, device controller 14 would be connected to controlled device 16 by direct connection 18. For example, direct connection 18 could include an electrical or optical cable, or another short-range connection.

When cyber-physical security module 12 is installed, direct connection 18 is broken and replaced with controller connection 20a between device controller 14 and cyber-physical security module 12 and with device connection 20b between cyber-physical security module 12 and controlled device 16. For example, a cable that previously formed direct connection 18 may be disconnected from device controller 14, controlled device 16, or both. One or more cables may be connected between cyber-physical security module 12 and device controller 14 to form controller connection 20a, and between cyber-physical security module 12 and controlled device 16 to form device connection 20b. Alternatively or in addition, one or more wireless communication units may be connected to cyber-physical security module 12 (e.g., and replaced on one or more of device controller 14 and controlled device 16) to intercept wireless communication between device controller 14 and controlled device 16. After formation of connection of controller connection 20a and of device connection 20b, all communication between device controller 14 and controlled device 16 may be intercepted by cyber-physical security module 12.

When a physical signal is generated by device controller 14, the physical signal is input via controller connection 20a to cyber-physical security module 12.

Cyber-physical security module 12 may evaluate one or more security criteria to determine whether the input signal that is received via controller connection 20a is authenticated. For example, cyber-physical security module 12 may determine whether the location of one or more external devices is indicative of authentication. Cyber-physical security module 12 may communicate with one or more communication devices to determine whether an operator of the communication device has authorized, and thus authenticated, the input signal. Alternatively or in addition, cyber-physical security module 12 may be configured to determine whether one or more conditions of operation are met time limits, environmental conditions, or other conditions of operation). Other criteria may be applied to authenticate the input signal.

If the input signal is authenticated, cyber-physical security module 12 may generate an output signal (e.g., identical or similar to the input signal). The output signal may be transmitted via device connection 20b to controlled device 16. Controlled device 16 may operate, e.g., in a similar manner to operation where device controller 14 communicates directly with controlled device 16 via direct connection 18.

If the input signal fails to be authenticated, no output signal is generated for transmission to controlled device 16. Therefore, controlled device 16 may not operate. In some cases, a notification of the failure may be transmitted to one or more destinations. For example, the destinations may include a security center, or a user or owner of controlled device 16. For example, the security rules may, upon failure to authenticate an input signal, cause generation of a signal that drives a LED to be activated (e.g., to flash red.

Alternatively or, more typically, in addition, device controller 14 controller is configured to receive a signal from controlled device 16 (e.g., a sensor reading, confirmation signal, or other type of signal). For example, a sensor may include a temperature sensor, pressure sensor, light or radiation sensor, accelerometer, or other type of sensor. In this case, cyber-physical security module 12 may be configured to authenticate a signal that is received by cyber-physical security module 12 from controlled device 16 via device connection 20b.

A malware infection or other unauthorized command to device controller 14 may originate at any interface between device controller 14 and the outside world. For example, the unauthorized command may originate in the Internet or cloud, LAN, USB memory stick, radio signal, corrupted firmware, or elsewhere. Regardless of origin, the unauthorized output signal from device controller 14 is intercepted by cyber-physical security module 12 and subjected to analysis that applies security rules to the signal. Only after authentication of the input signal is an output signal transmitted to controlled device 16.

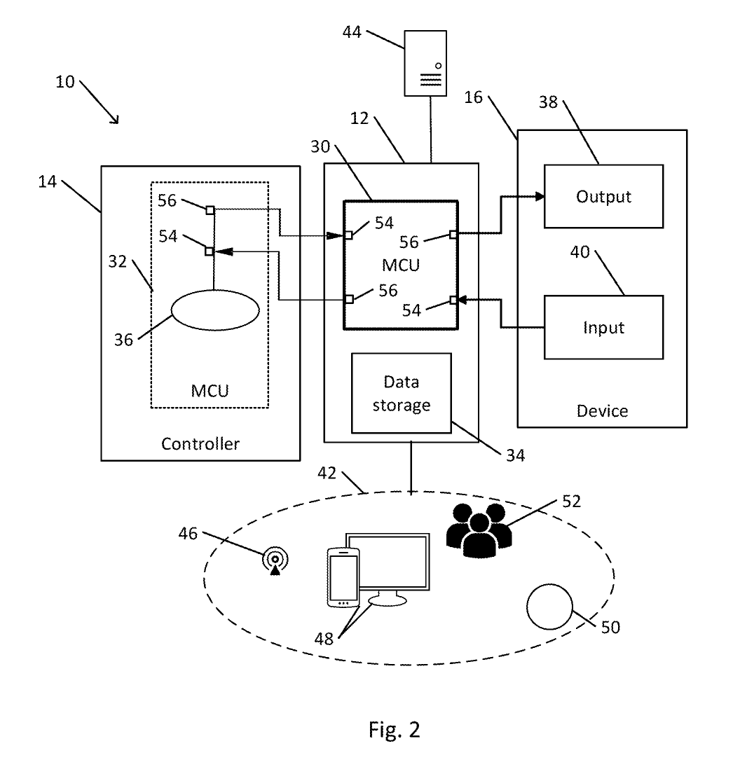

FIG. 2 is a schematic block diagram of an example of the cyber-physical security module of the system shown in FIG. 1.

In the example shown, device controller 14 includes an internal processor that is represented by controller micro-controller unit (MCU) 32. Controller micro-controller unit 32 may represent any type of processing capability based on control circuitry 36. Control circuitry 36 may represent one or more of programmable instructions on a data storage device, firmware, or hardware circuitry.

Device controller 14 may output a signal via one or more output connectors 56. Output connector 56 may include a general purpose input/output pin or connector, or other type of output connector. For example, output connector 56 may include a socket, clip, pin, or other structure that may enable connection to device controller 14 or controlled device 16, by mechanical contact, soldering, wirelessly, or otherwise. The output signal may be configured to connect to an output component 38 (e.g., an actuator or other device component that is configured to operate as a result of receiving the output signal) of controlled device 16.

Similarly, device controller 14 may receive a signal via one or more input connectors 54. Input connector 54 may include a general purpose input/output pin or connector, or other type of input connector. For example, input connector 54 may include a socket, clip, pin, or other structure that may enable connection to device controller 14 or controlled device 16, by mechanical contact, soldering, wirelessly, or otherwise. The input signal may originate from an input component 40 (e.g., a sensor or other device component that is configured to generate a signal in response to one or more conditions or events) of controlled device 16.

In the example shown, cyber-physical security module 12 includes a processor that is represented by security module microprocessor unit 30. Security module microprocessor unit 30 may represent one or more processing units, which may be separated from one another. For example, part of the functionality of security module microprocessor unit 30 may be provided by a remote unit that is in communication with a part of security module microprocessor unit 30 that is incorporated into cyber-physical security module 12. Security module microprocessor unit 30 may be configured to operate in accordance with programmed instructions.

Cyber-physical security module 12 includes data storage 34. For example, data storage 34 may include one or more volatile or non-volatile, fixed or removable, local or remotely accessed, memory, cache memory, or data storage devices. Data storage 34 may store programmed instructions for operation of security module microprocessor unit 30, data for utilization by security module microprocessor unit 30 when operating in accordance with the programmed instructions, results of operation of security module microprocessor unit 30, or other data.

For example, instructions may be stored in data storage 34 in the form of firmware.

Data storage 34 may be utilized to store programmed instructions that specify one or more user-defined authentication procedures. Data storage 34 may be utilized to store definitions or characteristics of one or more authentication entities 42. For example, data storage 34 may be used to store one or more authorized users of cyber-physical security system 10, access privileges, credentials, keys, access information, or other data related to authentication by cyber-physical security module 12.

Data storage 34 (e.g., a memory unit of data storage 34) may be utilized to store a signal (e.g., a digital signal) that is received via an input connector 54 of security module microprocessor unit 30. Alternatively or in addition, data storage 34 may be utilized to store sufficient characteristics of the received signal so as to enable generation of an identical or similar signal for transmission via an output connector 56 of security module microprocessor unit 30.

During execution of an authentication procedure, cyber-physical security module 12 may interact with one or more authentication entities 42. Authentication entities 42 may include a person, or an active or passive device.

For example, authentication entities 42 may include one or more authorized persons 52. An authorized person 52 may include a user, operator, or supervisor that is associated with cyber-physical security system 10. Authorized person 52 may include a user who is expected to operate controlled device 16. Authorized person 52 may include a supervisor or operator of cyber-physical security system 10. For example, the supervisor or operator may be associated with a security organization that installs, operates, supervises, or maintains one or more cyber-physical security systems 10.

For example, cyber-physical security module 12 may send a request for authentication to authorized person 52 when a signal is received. The request may include a message that is visibly (e.g., by a displayed message or icon) or audibly (e.g., verbally or as a tone) communicated via a user device 48 (e.g., a stationary or portable device with communication capability) that is associated with authorized person 52. Authentication by authorized person 52 may be indicated by operating the user device 48 (e.g., operating a screen control, or otherwise) to indicate authentication of the received signal. In some cases, authorized person 52 may be required to provide identifying information (e.g., identification code, password, or other identification) in order to authenticate a received signal. In some cases, authorized person 52 (e.g., a person that is associated with a service that operates, maintains, or supervises one or more cyber-physical security systems 10) may operate or supervise operation of a server 44.

Authentication entities 42 may include one or more user tokens 50. In this case, authentication of a received signal may include verifying that user token 50 is in the vicinity of cyber-physical security module 12. For example, a user token 50 may include an active or passive device (e.g., a radiofrequency identification tag (RFID), or other type of device) that is expected to be carried or worn by a user of controlled device 16 who enables generation of the received signal. In this case, authentication of the received signal may include detection of the presence of user token 50 by cyber-physical security module 12.

Authentication entities 42 may include one or more user devices 48. For example, a user device 48 may include a portable device (e.g., mobile phone, smartphone, tablet computer, laptop computer, or other type of portable device) that is expected to be carried by a user of controlled device 16. A user device 48 may include a capability of ascertaining its geographic position (e.g., using Global Positioning System (GPS) technology, or otherwise). Cyber-physical security module 12 may be configured to communicate with one or more user devices 48 to obtain a location of those user devices 48. Authentication of a received signal may include verifying that one or more user devices 48 are within a predetermined range of cyber-physical security module 12.

Authentication entities 42 may include one or more beacons 46. For example, cyber-physical security module 12 may include, operate, or may be associated with a beacon 46 (e.g., a BLE beacon, an IEEE 802.15.4 beacon, or other type of beacon) that may interact with one or more user devices 48 or user tokens 50. For example, a beacon 46 may be used to evaluate proximity of one or more user devices 48 or user tokens 50 that interact with a signal that is emitted by beacon 46. Alternatively or in addition, a beacon 46 may be assumed to be in close proximity to a user of controlled device 16. For example, a beacon 46 may be mounted on a vehicle that is associated with the user. In this case, cyber-physical security module 12 may be configured evaluate proximity of the user based on reception of signals from beacon 46.

Cyber-physical security module 12 may be configured to communicate with one or more servers 44. A server 44 may be operated by a service that maintains, supports, supervises, or is otherwise associated with one or more cyber-physical security systems 10. For example, a server 44 may host an application that supports operation of cyber-physical security module 12.

In some cases, cyber-physical security module 12 need not communicate with any authentication entities 42 or servers 44 during routine operation. In this case, cyber-physical security module 12 may be configured to execute self-contained cyber-physical security rules. For example, controlled device 16 may include a pulse-width modulation (PWM) driven electrical motor. In this case, cyber-physical security module 12 may be configured to restrict an output signal from device controller 14 to never exceed a predetermined duty cycle (e.g., 70%, or another duty cycle) for more than a predetermined duration (e.g., 1 minute, or another duration). In this case, for example, if the limits are exceeded (e.g., 1 minute has elapsed with over 70% duty cycle at the PWM input), then cyber-physical security module 12 may be configured to limit the output (e.g., to 70%). Further limits (e.g., if the input signal maintains 70% duty cycle for another 4 minutes, then no signal is transmitted to controlled device 16), or different limits, may be imposed.

For example, such a rule may be configured locally by an administrator (e.g., system installer) who connects to cyber-physical security module 12 over a universal asynchronous receiver/transmitter (UART) interface. Afterward, cyber-physical security module 12 may operate without any connection to the outside world.

An administrator may be authorized to define, modify, or configure security rules, e.g., when a new cyber-physical security module 12 is activated for the first time after leaving the factory. Cyber-physical security module 12 may be configured to receive input from the administrator, e.g., from an administrator device via an administrator connection, that defines, modifies, or otherwise configures one or a plurality of security rules. The administrator may be identified using strong authentication criteria (which may vary depending on the product model and required authentication type). Once the administrator is registered, the administrator may perform operations such as configuring cyber-physical security system 10, configuring security rules, defining other users, or other operations. In some cases, cyber-physical security system 10 may be configured to enable only a single administrator at one time. Thus, assignment of administrator privileges to another user may entail relinquishing administrator privileges by the original administrator.

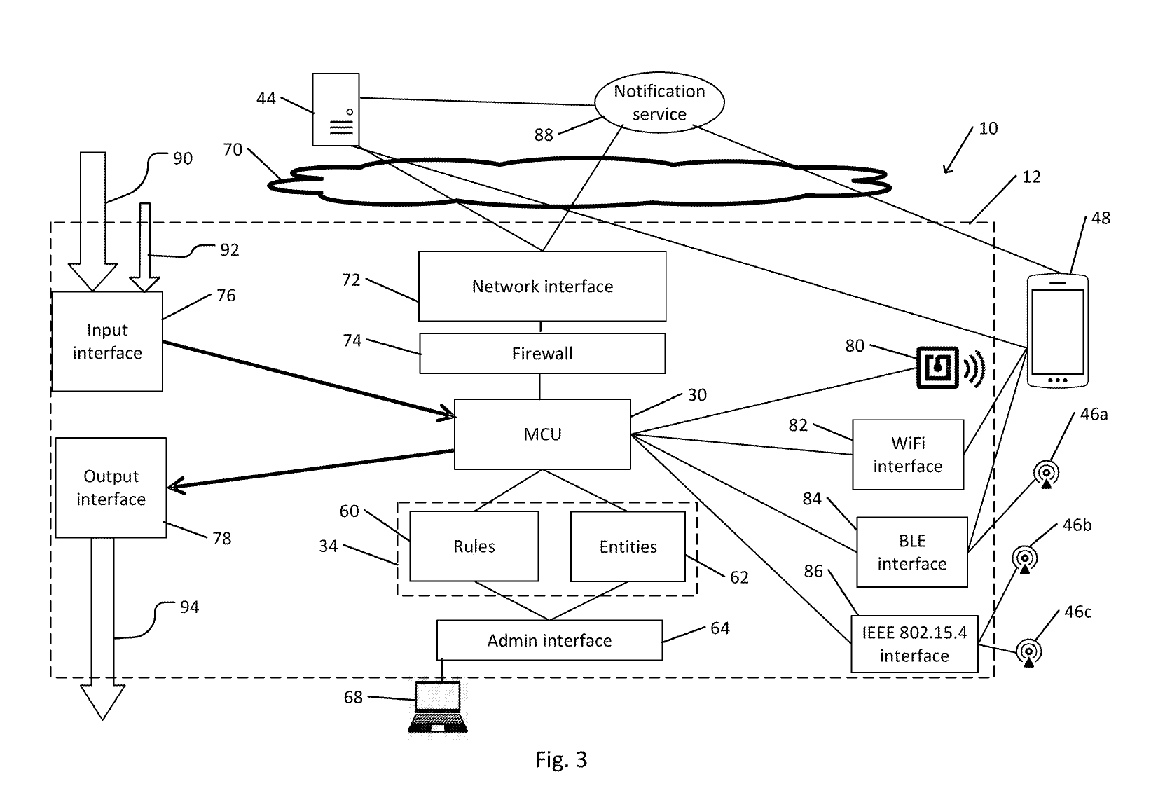

FIG. 3 is a schematic block diagram of elements of an example of the system shown in FIG. 1.

Input signals to input interface 76 of cyber-physical security module 12 may originate as one or more controller input physical signals 90 (e.g., as generated by a device controller 14). For example, a controller input physical signal 90 may include a signal that, if transmitted directly to controlled device 16, would cause (e.g., initiate, maintain, or modify) operation of controlled device 16. Input signals to input interface 76 may also include one or more sensor input physical signals 92. For example, a sensor input physical signal 92 may include a signal that is generated by a sensor of device controller 14 or of controlled device 16. For example, a sensor signal may include a sensor that senses a state of controlled device 16, an environmental condition, or another condition. A sensor (e.g., a passive infrared sensor or other sensor) may be configured to detect the presence of a person in the vicinity of cyber-physical security system 10. For example, detection of a person in an area where normally no person is expected to be found may be interpreted as being indicative of the current or previous presence of an intruder (e.g., resulting in application of stronger authentication criteria than would be applied otherwise).

Security module microprocessor unit 30 may be configured to detect and identify a controller input physical signal 90 or a sensor input physical signal 92. Security module microprocessor unit 30 may then operate as a cyber-physical security engine by executing one or more security rules 60 that are stored in data storage 34. Execution of security rules 60 may include examining the input signal (controller input physical signal 90 or sensor input physical signal 92) by applying various logical criteria to decide if the input signal is authenticated.

Execution of security rules 60 may including communicating with one or more authentication entities 42 as indicated in authentication entity database 62 stored in data storage 34. For example, authentication entity database 62 may list available or relevant authentication entities 42, may indicate an interface that is used to communicate with each authentication entity 42, may indicate a type of signal that is to be transmitted to, or a type of signal that may be expected to be received from, each authentication entity 42, or other information relevant to each authentication entity 42.

In one example (other examples are also relevant), cyber-physical security system 10 may include a controlled device 16 in the form of a motor or actuator of a garage door opener. In this example, device controller 14 may include a device that is configured to receive a signal that is transmitted by a garage door remote control (e.g., that is typically operated from inside a vehicle). Cyber-physical security module 12 may be connected between device controller 14 and the motor or actuator of controlled device 16. In this case, cyber-physical security system 10 may be configured to prevent accidental opening of the garage door due to a signal that is emitted by a nearby device, or intentional opening of the garage door by operation of an unauthorized remote control unit (e.g., operated by a potential burglar).

Cyber-physical security module 12 may be provided with one or more interfaces to enable communication or interaction with one or more authentication entities 42.

For example, cyber-physical security module 12 may be provided with a BLE interface 84. BLE interface 84 may communicate with one or more BLE beacons 46a. For example, in the case of a garage door opener, a BLE beacon 46a may be located in a garage or otherwise near controlled device 16 or device controller 14. Cyber-physical security module 12 may operate BLE interface 84 to determine if a user device 48 (e.g., a smartphone or other portable device that is expected to be close to a user) is in communication with, and thus in close proximity to, BLE beacon 46a. If close proximity is indicated, then the input signal may be authenticated.

Alternatively or in addition, BLE interface 84 may be utilized to transmit an authentication request message to user device 48 via Bluetooth communication between BLE interface 84 and user device 48. The user may then operate user device 48 (by operation of a screen control) to transmit an authentication verification message to BLE interface 84 via Bluetooth communication. Similarly, a Wi-Fi interface 82 may be used to transmit an authentication request message to, and to receive an authentication verification message from, a user device 48.

Cyber-physical security module 12 may be provided with an IEEE 802.15.4 interface 86. For example, IEEE 802.15.4 interface 86 may operate an IEEE 802.15.4 beacon 46b (e.g., located in or near the garage) to verify the proximity of a (IEEE 802.15.4) user token 50 that is expected to be near the user (e.g., on a keychain or elsewhere). Similarly, cyber-physical security module 12 may include a near field communication interface 80 that may be operated used to verify proximity of a user token 50 (e.g., with an RFID tag or a near field communication-enabled smartphone).

Alternatively or in addition, IEEE 802.15.4 interface 86 may be operated to verify that an IEEE 802.15.4 beacon 46c that is expected to be near the user (e.g., installed in the user's vehicle or elsewhere) is in close proximity to cyber-physical security module 12.

An authentication request may be sent to a user device 48 via a network 70. Network 70 may include the Internet, telephone network, or another communications network. Cyber-physical security module 12 may include a network interface 72 to enable communication via network 70. For example, network interface 72 may include an Ethernet interface, a 3G mobile interface, a 4G mobile interface, or another type of network interface.

Communications via network interface 72 may be protected by firewall 74. For example, firewall 74 may include an embedded firewall (e.g., Zilog Zgate™, or another embedded firewall).

For example, an authentication request may be sent to user device 48 via network 70 and notification service 88. For example, notification service 88 may include a service such as Google Cloud Messaging, Apple Push Notification Service, or another notification service. An authentication verification message may be received from user device 48 also via notification service 88, network 70, and network interface 72.

As another example, cyber-physical security module 12 may send a server authentication request to server 44. Server 44 may be operated, for example, by a service that operates, maintains, or supports one or more cyber-physical security systems 10. Upon receiving the authentication request, server 44 may send an authentication request to user device 48, e.g., via network 70, notification service 88, or otherwise. An authentication verification message that is generated by user device 48 may be transmitted to server 44. Server 44 may then transmit a server authentication verification message to cyber-physical security module 12 via network 70. Alternatively or in addition, an authentication verification message that is generated by user device 48 may be transmitted directly to cyber-physical security module 12 (e.g., not via sever 44), e.g., via one or both of notification service 88 and network 70.

Incoming communications may be also used as criteria for security rules. For example, controlled device 16 may transmit to cyber-physical security module 12 one or more indications of a status (e.g., related to alerts, operation, or otherwise).

If application of security rules 60 results in successful verification and authentication of controller input physical signal 90, sensor input physical signal 92, or both, cyber-physical security module 12 may transmit an authenticated output physical signal 94 via output interface 78. Authenticated output physical signal 94 may be identical to, or similar to, controller input physical signal 90 or sensor input physical signal 92. For example, an authenticated output physical signal 94 that is similar or identical to controller input physical signal 90 may be transmitted to controlled device 16 (e.g., a garage door actuator to open a garage door, or to another device). An authenticated output physical signal 94 that is similar or identical to sensor input physical signal 92 may be transmitted to device controller 14.

Cyber-physical security module 12 may be configured to maintain a log of events (e.g., successful or unsuccessful authentication), data, or other information, e.g., on data storage 34. The information may be transmitted to one or more devices, such as server 44, user device 48, or to another device, via one or more communications channels (e.g., via network interface 72, Wi-Fi interface 82, BLE interface 84, or another interface or channel. For example, the information may be utilized by server 44 or by another device in communication with one or more cyber-physical security systems 10 to enable analysis of the events and data. For example, detection of trends or threats, or other analysis of the information may result in modification of all or part of security rules 60 (e.g., increasing strictness of security rules 60, or another modification).

One or more of security rules 60, authentication entity database 62, or other information stored on data storage 34 may be entered, defined, modified, or otherwise accessed by administrator device 68 via administrator interface 64. Administrator device 68, or an administrator that operates administrator device 68, may be identified using strong authentication criteria.

Security rules 60 may be defined using a programming language, referred to herein as a cyber-physical security language (CPSL). For example, CPSL may be designed to be user friendly and intuitive to a person who is familiar with English or another spoken language.

CPSL may be utilized to define various asynchronous events that trigger a security rule 60, or a set or sequence of security rules 60, to be executed by microprocessor unit 30. For example, an event may include a transition of a digital input from one state to another, expiration of a timer, data received on a communications channel, or another event.

CPSL may be utilized to define one or more security functions, e.g., actions that are to be executed by the cyber-physical security module 12, e.g., upon occurrence of an event.

CPSL may provide one or more CPSL primitive functions that may be utilized to construct a security function. For example, CPSL primitive functions may define functionality such as outputting a signal, return the value of an input analog or digital signal, start a timer, authenticate a user, or another function.

A CPSL compound function may be assembled to form a named compound function that may be invoked by similarly to a CPSL primitive function.

A CPSL custom function may be created by a developer using a development environment. The created CPSL custom function may be downloaded or pre-stored in data storage 34 of cyber-physical security module 12. For example, a CPSL custom function could include an algorithm to analyze an event that occurs in cyber-physical security module 12 or cyber-physical security system 10, and to yield a result that is used by security rules 60 in order to achieve a target level of security.

CPSL may provide various logical and branching operators (e.g., AND, OR, NOT, IF, ELSE, or other operators).

A security rule 60 may have a form as in (in pseudo-language) the following example:

On PB3 LEADING EDGE://

If digital input port B bit 3 switches from LOW to HIGH

SAMPLE&HOLD (PB3, 5) //

Sample the port for 5 seconds and store sampled signal in

memory

AUTHENTICATE local user (Bluetooth) AND Supervisor (Cloud)
ON SUCCESS: PLAYBACK( ) // Playback the sampled signal
ON FAIL: SET_LED(RED, BLINK)

In the above example, an event is defined by an input signal via a particular input port (port B, bit 3) that switches from low to high. When the event occurs, the input signal (through port B, bit 3) is sampled for a period of time (5 seconds) and stored in memory. An authentication request is then sent to a local user via Bluetooth, and to a supervisor via a network (cloud). If authentication is received, the sampled signal is played back (e.g., to operate a device). If authentication fails (e.g., no authentication verification message is received within a predetermined period of time), a red indicator light (light emitting diode) is caused to blink.

Is some cases, communication among different cyber-physical security modules 12 may be enabled (e.g., via IEEE802.15.4, Bluetooth, Wi-Fi, or otherwise). Such inter-module communication may be highly secured. The inter-module communication may be utilized to exchanging data (e.g., users, rules, parameters, functions, or other data) among cyber-physical security modules 12.

Any communications by cyber-physical security module 12, whether with another cyber-physical security module 12, with a server 44, with a user device 48, with an administrator device 68, or otherwise (e.g., via Bluetooth, IFEE802.15.4, Internet, or otherwise), may be strongly encrypted using state-of-the-art encryption technologies and authentication mechanisms. Integrity of firmware in cyber-physical security module 12 may be protected by state-of-the-art software signing mechanisms.

Cyber-physical security system 10 may be protected from side channel attacks. For example, passive protection by may be provided by electromagnetically shielding all of cyber-physical security module 12 (e.g., excluding antennas). The shielding may reduce the potential of an electromagnetic signal being emitted that could be detected by potentially malicious eavesdropping equipment. Active protection may include executing “dummy tasks” that generate electromagnetic signals that are not indicative of function of cyber-physical security module 12. These dummy signals may then function as decoy or jamming signals to any potentially malicious eavesdropping equipment. In some cases, a radio transmitter and antenna may be utilized to increase the intensity of the dummy signals, thus achieving a high jamming-to-signal ratio. Since side channel attack receivers are typically operated to extract critical information such as encryption keys, the dummy signal that is uncorrelated to the secret data may inhibit or prevent such an attack.

In some cases (e.g., in the case of industrial, infrastructure and defense applications), additional security protection may be required. For example, protection may be extended to a foundry in order to prevent any tampering or cloning at the level of the electronic components. Such protection may be achieved by procedural measures (e.g., by highly secured production areas), by technological measures, or otherwise.

Cyber-physical security module 12, e.g., microprocessor unit 30 of cyber-physical security module 12, may be configured to execute a method for cyber-physical security.

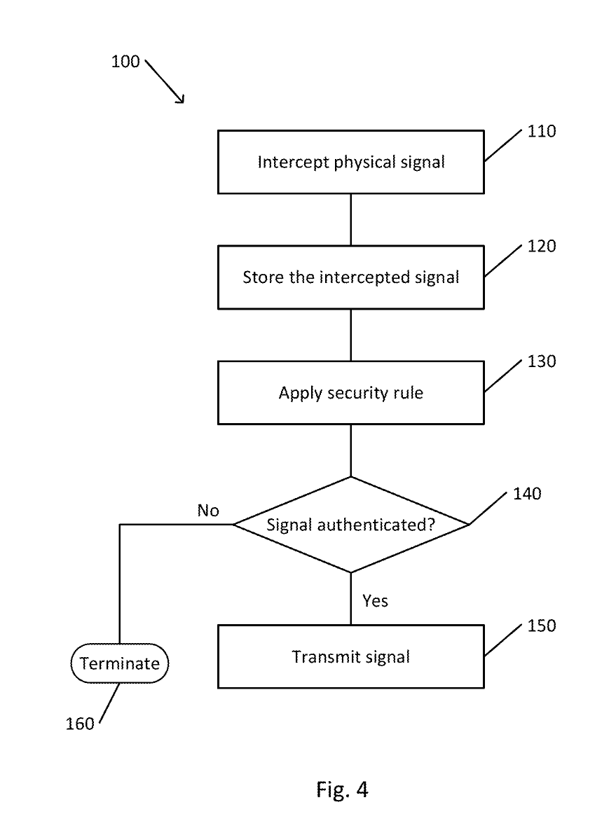

FIG. 4 is a flowchart depicting a method for cyber-physical security, in accordance with an embodiment of the present invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Cyber-physical security method 100 may be executed by cyber-physical security module 12 when cyber-physical security module 12 is connected to a signal source and a signal destination. For example, cyber-physical security module 12 may be connected to a device controller 14 and a controlled device 16. In some situations, device controller 14 may function as the signal source, e.g., of a controller input physical signal 90, and controlled device 16 may function as the signal destination. In other situations, controlled device 16 may function as the signal source, e.g., of a sensor input physical signal 92, and device controller 14 may function as the signal destination.

Cyber-physical security method 100 may be executed by cyber-physical security module 12 in response to an event. For example, the event may include arrival of a physical signal to input interface 76, proximity to a device, or another event.

A physical signal that is transmitted from a signal source for receipt by a signal destination may be intercepted by cyber-physical security module 12 via input interface 76 (block 110). In some cases, a physical signal that is intercepted or that triggers execution of cyber-physical security method 100 may be limited to a signal that conforms to one or more criteria (e.g., minimum change in voltage, minimum duration, or other criteria). For example, the physical signal may represent a controller input physical signal 90 from a device controller 14, a sensor input physical signal 92 from device controller 14 or from controlled device 16 (or another sensor), or another physical signal.

The intercepted physical signal may be stored (block 120). For example, the physical signal may be stored in a memory unit of data storage 34.

One or more security rules 60, e.g., as defined, programmed, or modified by an administrator, may be applied (block 130). For example, the applied security rules may determine if communication is established with one or more authentication entities 42, e.g., as defined by authentication entity database 62. In some cases, an authentication request may be sent to one or more servers 44 or user devices 48. In some cases, sensor input physical signal 92 may be interpreted to determine a sensed condition. In some cases, other communicated data may be utilized in applying security rules 60.

The signal may be authenticated (block 140). For example, vicinity of an authentication entity 42 may be verified, an authentication verification message may be received, or another authentication criterion may be satisfied.

If the signal is authenticated, the intercepted signal may be transmitted to its destination (block 150). In a case that the intercepted signal was stored, the stored signal may be transmitted. For example, the destination may be a controlled device 16 to cause operation of the device, a device controller 14, or another destination.

If the signal is not authenticated, execution of cyber-physical security method 100 may terminate (block 160). In some cases, termination may be preceded by one or more actions. For example, a stored signal may be deleted or may be flagged to enable overwriting. A notification may be sent to server 44 or to user device 48. One or more indicators, e.g., on cyber-physical security module 12, within cyber-physical security system 10, or elsewhere may be activated. The indicator may include a displayed message, a tone, an indicator light, or another indicator.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A cyber-physical security module comprising:
an input interface configured to connect to a signal source to intercept a physical signal that is transmitted from the signal source to a signal destination;
an output interface configured to connect to the signal destination; and
a programmable processor that is configured to:
receive input from an administrator device to define or modify one or a plurality of security rules;
upon interception of the physical signal via the input interface, apply said one or a plurality of security rules to authenticate the intercepted physical signal; and
if the intercepted physical signal is authenticated, transmit the intercepted physical signal to the signal destination via the output interface.

2. The cyber-physical security module of claim 1, wherein the signal source comprises a controller, and the signal destination comprises a controlled device.

3. The cyber-physical security module of claim 1, wherein the signal source comprises a controlled device, and the signal destination comprises a controller.

4. The cyber-physical security module of claim 3, wherein the physical signal comprises a sensor signal.

5. The cyber-physical security module of claim 1, further comprising an interface to a beacon.

6. The cyber-physical security module of claim 5, wherein the security rule comprises proximity of a security entity as detected by operation of the beacon.

7. The cyber-physical security module of claim 6, wherein the security entity comprises a user device or a token.

8. The cyber-physical security module of claim 5, wherein the security rule comprises communicating with a user device via the beacon.

9. The cyber-physical security module of claim 1, wherein the security rule comprises receipt of an authentication verification message from a user device or from a server.

10. The cyber-physical security module of claim 1, wherein the security rule comprises proximity of a beacon.

11. The cyber-physical security module of claim 1, further comprising a data storage, the processor being further configured to store the intercepted physical signal in the data storage.

12. A cyber-physical security method, the method comprising:
intercepting a physical signal by a cyber-physical security module from a signal source that is connected to an input interface of the cyber-physical security module;
storing the intercepted physical signal on a data storage;
applying one or a plurality of security rules to authenticate the intercepted physical signal; and
if the intercepted physical signal is authenticated, transmitting the stored physical signal to a signal destination that is connected to an output interface of the cyber-physical security module.

13. The method of claim 12, wherein the signal source comprises a controller and the signal destination comprises a controlled device.

14. The method of claim 12, wherein the signal source comprises a controlled device and the signal destination comprises a controller.

15. The method of claim 14, wherein the physical signal comprises a sensor signal.

16. The method of claim 12, wherein applying said one or a plurality of security rules comprises transmitting an authentication request message to a user device or to a server.

17. The method of claim 12, wherein applying said one or a plurality of security rules comprises detecting the proximity of a token.

18. The method of claim 12, wherein applying said one or a plurality of security rules comprises detecting the proximity of a user device.

19. The method of claim 12, wherein applying said one or a plurality of security rules comprises detecting the proximity of a beacon.

20. The method of claim 12, further comprising receiving input from an administrator device to define or modify said one or a plurality of security rules.
